(19) United States
(12) Patent Application Publication
(10) Pub. No.: US 2013/0051236 A1
(43) Pub. Date: Feb. 28, 2013

(54) Wireline Nodal QoS-Based Routing

(71) Applicant: Terry Bush, Parker, TX (US)

(72) Inventor: Terry Bush, Parker, TX (US)

(21) Appl. No.: 13/220,628

(22) Filed: Aug. 29, 2011

(51) Int. Cl. H04L 12/26; H04L 12/56

(52) U.S. Cl. 370/237; 370/235

(57) ABSTRACT

A node of a packet switched telecommunications network includes a network interface unit which sends and, receives data from the network. The node includes a processing unit which performs real-time Quality of Service (QoS) measurements on the data and routes the data through the network interface to the network based on the QoS measurements. A method for routing data by a node of a packet switched telecommunications network including the steps of sending and receiving data to and from the network with a network interface of the node. There is the step of performing real-time Quality of Service (QoS) measurements on the data with a processing unit of the node. There is the step of routing the data with the processing unit through the network interface to the network based on the QoS measurements.

### TECHNICAL FIELD

The present invention is related to routing data based on Quality of Service (QoS) measurements. (As used herein, references to the “present invention” or “invention” relate to exemplary embodiments and not necessarily to every embodiment encompassed by the appended claims.) More specifically, the invention is related to routing data based on real-time QoS measurements which may include at least one of packet loss, jitter, delay, packet duplication, or packet re-ordering in regard to the data.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

A packet media processor (MP) processes any combination of media such as voice, circuit switched data, video, and images, and communicates with a packet switched network. In order to provide redundancy, the MP will have greater than one path to the packet switched network. Given multiple paths, the MP must make a routing decision on which path or paths to send traffic (egress traffic from the perspective of the MP). The path, or paths, chosen for traffic inbound to the MP (ingress traffic from the perspective of the MP) may be a decision of the packet switched network or may be under the control of the MP.

There are several techniques which may be incorporated to determine the preferred route for traffic assuming greater than one path is available.

The preferred route may be statically defined. In this case, provisioning information is established providing a priority order over multiple paths. The path selection may also be dynamic where the path is chosen based on factors or influences from the network. These techniques employee the use of network protocols which dynamically select the preferred path based on criteria such as:
Cost
Administrative weight
Shortest path
Physical bandwidth
Other factors

The term “metric” will be used in this disclosure to generically reference the priority for a given path regardless of the criteria used.

An objective for multimedia networks is to offer a good Quality of Service (QoS) for the end user. QoS can be measured at an MP by examining the following parameters (but not limited to):
Packet loss
Jitter
Delay
Packet Duplication
Packet Reordering

MPs measure all of the above mentioned QoS parameters, however, any node which can measure one or more of the above QoS parameters can employ the Nodal QoS-based Routing. This implies that applications other than voice, circuit switched data, video, or images could benefit. For example, a data transport protocol that is aware of chronic packet loss, may choose alternative local routing in an attempt to improve its observed QoS.

Existing routing solutions work on a metric basis, derived statically or dynamically, which does not include real time Quality of Service (QoS) measurements available at the end nodes.

QoS Routing, in the Internet [RFC 2386] investigates routing techniques which incorporate QoS requirements. It is based on network resource availability that has a “good chance of accommodating” the requested QoS but not on actual real time measured QoS as experienced at the end nodes. Faulty hardware can be the source of poor QoS which is not accountable when using a reservation scheme even when including QoS requirements for a given flow. The scope for this concept includes the routing devices but not necessarily the end nodes.

In contrast, Wireline Nodal QoS-based Routing's scope is local to the end node and its interfaces. However, by accompanying Wireline Nodal QoS-based Routing with network flow schemes which ensure segregated paths, such as Multi-Protocol Label Switching (MPLS) or Internet Protocol version 6 (IPv6) Flow Labels, the Wireline Nodal QoS-based Routing can offer an end-to-end solution where the decision points are placed at the nodes which have the real time QoS statistics.

Wireless access equipment may choose one cell vs. another cell for communicating to a wireless terminal in order to gain the optimal QoS. This is similar in nature to the Nodal QoS-Based Routing in that one air channel is preferred over another based on observed QoS but does not integrate with routing techniques as does the wireline interfaces.

### BRIEF SUMMARY OF THE INVENTION

The present invention pertains to a node of a packet switched telecommunications network. The node comprises a network interface unit which sends and receives data from the network. The node comprises a processing unit which performs real-time Quality of Service (QoS) measurements on the data and routes the data through the network interface to the network based on the QoS measurements.

The present invention pertains to a method for routing data by a node of a packet switched telecommunications network. The method comprises the steps of sending and receiving data to and from the network with a network interface of the node. There is the step of performing real-time Quality of Service (QoS) measurements on the data with a processing unit of the node. There is the step of routing the data with the processing unit through the network interface to the network based on the QoS measurements.

### BRIEF DESCRIPTION OF THE DRAWING

In the accompanying drawings, the preferred embodiment of the invention and preferred methods of practicing the invention are illustrated in which:

FIG. 1 shows redundant paths of the present invention.

FIG. 2 shows separate network paths of the present invention.

FIG. 3 shows Active-Standby.

FIG. 4 shows simultaneous switch-over at both end nodes.

FIG. 5 is a block diagram of a node.

### DETAILED DESCRIPTION

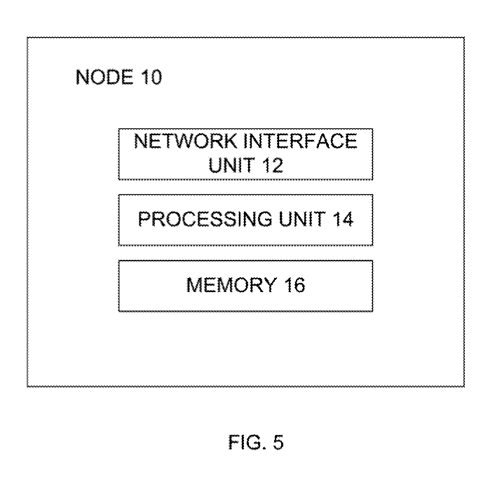

Referring now to the drawings wherein like reference numerals refer to similar or identical parts throughout the several views, and more specifically to FIG. 5 thereof, there is shown a node 10 of a packet switched telecommunications network. The node 10 comprises a network interface unit 12 which sends and receives data from the network. The node 10 comprises a processing unit 14 which performs real-time Quality of Service (QoS) measurements on the data and routes the data through the network interface to the network based on the QoS measurements.

The processing unit 14 may measure at least one of packet loss, jitter, delay, packet duplication, or packet re-ordering in regard to the data. There may be at least two paths for sending and receiving the data through the network interface unit 12 to or from the network. The processing unit 14 may choose at least one path for sending and receiving the data based on either statically defined or dynamic routing information. The processing unit 14 may establish at least one minimum acceptable quality of service threshold which, if not met by the data, causes the processing unit 14 to select an alternate path for the data.

The processing unit 14 may also use a link integrity check algorithm to route the data. The node 10 may include a memory 16, and wherein the processing unit 14 may determine a quality of service score for each link in a link group and may store each quality of service score in the memory 16, and if at least one of the quality of service scores falls below the minimum threshold, the processing unit 14 may alter the routing of the data to another link group. Alternatively, the processing unit 14 may determine a quality of service score for each link in a link group and may store each quality of service score in the memory 16, and the processing unit 14 may remove a quality of service link from the link group that has, a quality of service score below the minimum threshold. There may be an active path and an idle path in regard to the data, and the processing unit 14 measures the quality service of the active path.

The node 10 may include a hold down timer, and wherein when the quality of service of the active path falls below a quality of service threshold, the processing unit 14 may divert the data to the idle path and start the hold down timer which prevents oscillation of the data being diverted back to the active path if the quality service of the idle path is below the quality service threshold. The holddown timer may prevent the processing unit 14 from diverting the data to a path having a quality of service below the quality of service threshold which counteracts another node 10 also diverting the data so the data is not diverted from the path having a quality of service below the quality of service threshold.

The present invention pertains to a method for routing data by a node 10 of a packet switched telecommunications network. The method comprises the steps of sending and receiving data to and from the network with a network interface of the node. There is the step of performing real-time Quality of Service (QoS) measurements on the data with a processing unit 14 of the node 10. There is the step of routing the data with the processing unit 14 through the network interface to the network based on the QOS measurements.

There may be the step of measuring with the processing unit 14 at least one of packet loss, jitter, delay, packet duplication, or packet re-ordering in regard to the data. There may be at least two paths for sending and receiving the data through the network interface unit 12 to or from the network. There may be the step of choosing with the processing unit 14 at least one path for sending and receiving the data based on either statically defined or dynamic routing information. There may be the step of establishing with the processing unit 14 at least one minimum acceptable quality of service threshold which, if not met by the data, causes the processing unit 14 to select an alternate path for the data.

There may be the step of using a link integrity check, algorithm by the processing unit 14 to route the data. There may be the steps of determining with the processing unit 14 a quality of service score for each link in a link group and storing by the processing unit 14 each quality of service score in a memory 16, and if at least one of the quality of service scores: falls below the minimum threshold, the processing unit 14 altering the routing of the data to another link group.

There may be the steps of determining with the processing unit 14 a quality of service score for each link in a link group, and the processing unit 14 storing each quality of service score in the memory 16, and the processing unit 14 removing a quality of service link from the link group that has a quality of service score below the minimum threshold. There may be an active path and an idle path in regard to the data, and including the step of the processing unit 14 measuring the quality service of the active path.

There may be a hold down timer, and wherein when the quality of service of the active path falls below a quality of service threshold, there may be the steps of the processing unit 14 diverting the data to the idle path and starting the hold down timer which prevents oscillation of the data being diverted back to the active path if the quality service of the idle path is below the quality service threshold. There may be the step of the holddown timer preventing the processing unit 14 from diverting the data to a path having a quality of service below the quality of service threshold which counteracts another node 10 also diverting the data so the data is not diverted from the path having a quality of service below the quality of service threshold.

In the operation of the invention, Wireline Nodal QoS-based Routing utilizes real time QoS measurements observed at the Node 10 or Media Processor as an input to its local routing decisions in order to offer the required QoS for the media stream.

Based on ingress traffic, the source node 10 calculates any combination of
Packet Loss
Jitter
Delay

Packet Duplication

Packet Reordering

as received from the far-end node 10.

If supporting a feedback protocol such as Real-Time Transport Protocol (RTCP) [RFC 3550], this information is fed back to the far end node 10. Likewise, the far end node 10 may provide the same information which relates to the source node's egress traffic, back to the source node 10. The QoS statistics as witnessed by the destination node 10 are feed back to the source node 10. Although, not necessary for this invention to work, the addition of the feedback information provides both ingress and egress QoS.

Without the feedback QoS information, the source node 10 makes a routing change based on the assumption that both directions of traffic are experiencing a similar QoS.

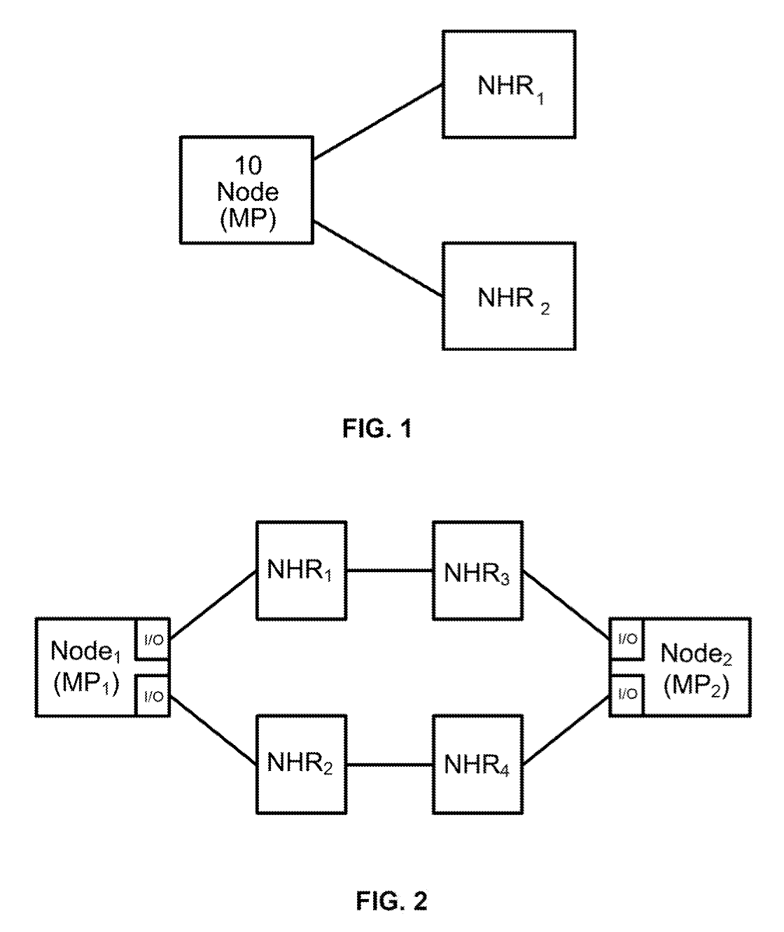

It is assumed for redundancy purposes that the wireline node 10 has greater than one path for transmitting and receiving traffic. In order to gain independent paths associated with the node 10, it must connect to a minimum of two routing devices. These devices will be referred to as next hop routers (NHR) herein as shown in FIG. 1.

The node 10, or media processor, has an algorithm for selecting which path, or paths, it will transmit traffic. Under certain circumstances, the node 10 may also be able to influence the path used for ingress traffic.

Before considering the QoS influence, the routing decision may be statically defined or based on dynamic routing information where the node 10 will transmit on the path with the most favorable metric.

A single threshold or a combination of thresholds, which may be adjustable, are established to determine the minimum acceptable QoS. If the QoS threshold is not met, then the system alarms the event with specific details of the problem source, and an alternative route is selected. This opens the opportunity to utilize a different local node 10 I/O card, cables, NHR, and potentially different core network routers and paths. With the use of deterministic routing across the network such as MPLS, a separate network path can be guaranteed as well providing completely different end-to-end paths, as shown in FIG. 2.

The algorithm to influence an alternative route is implementation dependent but adjusting the cost metrics could be one solution that would work with both static and dynamic routing techniques.

Note that Wireline Nodal QoS-based Routing works with link integrity check algorithms, such as Bidirectional Forwarding Detection (BFD) [RFC 5880], and does not alter their influence on working paths. For example, if a link is determined to be out of service, then it is removed from the route selection with our without the Wireline Nodal QoS-based Routing.

This invention applies to any device which can observe QoS characteristics of the data stream and influence routing decisions.

Other considerations are addressed below.

If multiple links in a link group are utilized between the Node 10 and the NHRs then a QoS score can be kept for all. If the QoS of one, or more, of the links in the group falls below the minimum threshold, then the same algorithm can be used to alter the preferred path to another link group, just as before with a single link.

Removing a poor QoS link from a link group is another possible algorithm.

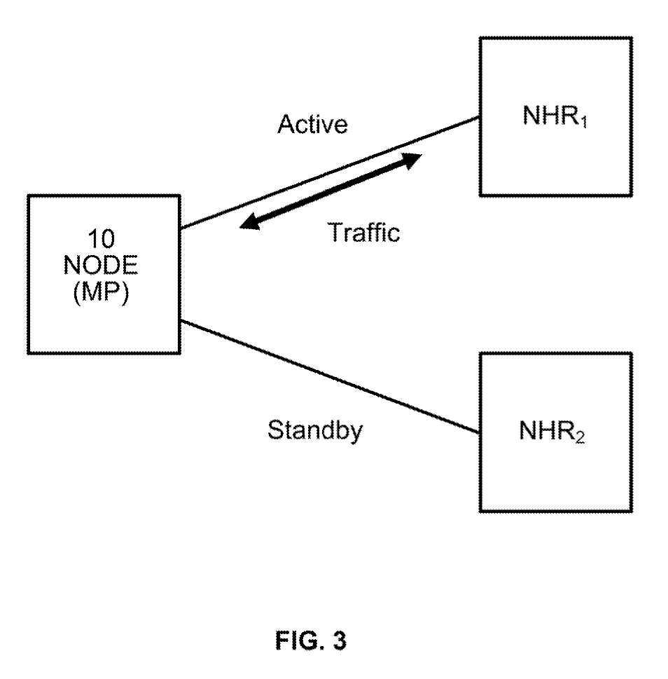

Referring to FIG. 3, Active-Standby implies that one path carries the traffic while other alternative path(s) remain idle. In this case, the QoS, on the active path is effectively measured. The QoS cannot be measured on the standby path(s) as it carries no traffic where QoS metrics are measured. It is unknown if the switch-over from the active to a standby path will improve the QoS. However, if the current path does not deliver minimal QoS, then an alternative path should be attempted. Ideally, there is a mechanism to control oscillation between paths. If multiple active paths are utilized, then QoS can be measured on each active path transferring media.

A mechanism will need to be in place to ensure path oscillation does not occur. For example, given two paths, one active, and one standby, if the active path falls below the QoS threshold, traffic is diverted to the standby path, and if the QoS is again below the threshold, then there will be a tendency to bounce back to the original active path. This starts an oscillation. A hold down timer needs to be in place to control oscillation.

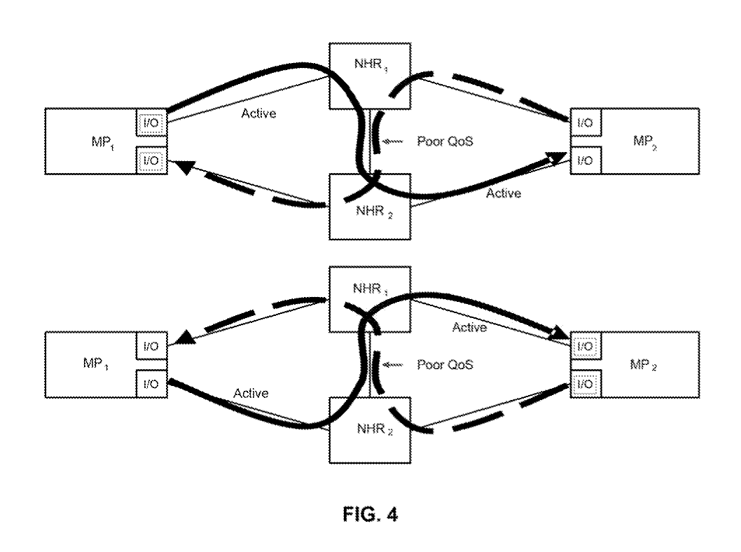

The hold down timer should be based on an exponential back-off algorithm. (It should be noted, this is an option. It is a popular technique. Other algorithms may be utilized). The purpose behind this is to provide variability on when the switch over decision between two end nodes 10 that both support Wireline Nodal QoS-based Routing. Assuming predictable routing, e.g., MPLS, is not being utilized across the network, then it's possible that both end nodes choosing alternative routes locally will counteract each other and will not divert around a poor QoS in the network. See FIG. 4.

The Carrier Sense Multiple Access with Collision Detection (CSMA/CD) technique, incorporated by reference herein, includes an exponential back-off algorithm. This algorithm is utilized in the case of packet collisions to determine when to attempt to retransmit the packet. Given that 2 or more nodes have collided packets, they each generate a random number within a time range, wait that time, and then attempt to re-send. In the case of repetitive collisions, the time window for the random number generator doubles, (i.e., exponential), theoretically reducing the probability of consecutive collisions.

Congestion

Congestion can degrade QoS:
Increased packet loss
Increased jitter
Increased delay
Packet Duplication
Packet Reordering

Congestion may be caused by improper engineering of the nodes or routers vs. anticipated traffic levels and is not the fault of a given path. In this case, altering the path may or may not improve QoS. Link oscillation will need to be managed in this case.

In other cases, one path may experience congestion, while others do not due to different path equipment and characteristics. In this case, altering the path does improve QoS.

Detection of this Algorithm

Introduce poor QoS onto a link at the node 10 in question. Poor QoS can be:
Increased jitter
Increased packet loss (but not to the point that the node 10 assumes the path is down)
Increased delay
Packet Duplication
Packet Reordering
Others
Any combination of the above

Network tools are commercially available which allow adjustment of jitter, packet loss, delay, and generate packet duplication and reordering on a given interface.

Given no other alterations in the network topology, e.g., no link loss, if a route change takes place, then it indicates this algorithm is in use Link integrity protocols, such as BFD, may be monitored on the links to ensure they were not the cause of the path change.

Standards

It is not mandatory to alter standards in order to introduce this capability.

### ADVANTAGES OF THE INVENTION

Real time adjustments based on actual observed QoS parameters. Routing decision is contained locally to the Media Processor, or node 10 performing the real time measurements, avoiding overhead on all routing devices in the network.

### ABBREVIATIONS

ARP Address Resolution Protocol

MP Media Processor

MPLS Multi-Protocol Label Switching

NHR Next Hop Router

QoS Quality of Service

RFC Request for Comments

RTCP Real-Time Control Protocol

RTP Real Time Protocol

References, all of which are Incorporated by Reference Herein
RFC 2386 A Framework for QoS-based Routing in the Internet, Informational, August 1998
RFC 3550 RTP: A Transport Protocol for Real-Time Applications, Standard, July 2003
RFC 5880 Bidirectional Forwarding Detection (BFD), Standard, June 2010

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A node of a packet switched telecommunications network comprising:
a network interface unit which sends and receives data from the network; and
a processing unit which performs real-time Quality of Service (QoS) measurements on the data and routes the data through the network interface to the network based on the QoS measurements.

2. The node as described in claim 1 wherein the processing unit measures at least one of packet loss, jitter, delay, packet duplication, or packet re-ordering in regard to the data.

3. The node as described in claim 1 wherein there are at least two paths for sending and receiving the data through the network interface unit to or from the network.

4. The node as described in claim 3 wherein the processing unit chooses at least one path for sending and receiving the data based on either statically defined or dynamic routing information.

5. The node as described in claim 4 wherein the processing unit establishes at least one minimum acceptable quality of service threshold which, if not met by the data, causes the processing unit to select an alternate path for the data.

6. The node as described in claim 1 wherein the processing unit also uses a link integrity check algorithm to route the data.

7. The node as described in claim 5 including a memory, and wherein the processing unit determines a quality of service score for each link in a link group and stores each quality of service score in the memory, and if at least one of the quality of service scores falls below the minimum threshold, the processing unit alters the routing of the data to another link group.

8. The node as described in claim 5 including a memory, and wherein the processing unit determines a quality of service score for each link in a link group and stores each quality of service score in the memory, and the processing unit removes a quality of service link from the link group that has a quality of service score below the minimum threshold.

9. The node as described in claim 1 wherein there is an active path and an idle path in regard to the data, and the processing unit measures the quality service of the active path.

10. The node as described in claim 9 including a hold down timer, and wherein when the quality of service of the active path falls below a quality of service threshold, the processing unit diverts the data to the idle path and starts the hold down timer which prevents oscillation of the data being diverted back to the active path if the quality service of the idle path is below the quality service threshold.

11. The node as described in claim 10 wherein the holddown timer prevents the processing unit from diverting the data to a path having a quality of service below the quality of service threshold which counteracts another node also diverting the data so the data is not diverted from the path having a quality of service below the quality of service, threshold.

12. A method for routing data by a node of a packet switched telecommunications network comprising the steps of
sending and receiving data to and from the network with a network interface of the node; and
performing real-time quality of service (QOS) measurements on the data with a processing unit of the node; and
routing the data with the processing unit through the network interface to the network based on the QOS measurements.

13. The method as described in claim 12 including the step of measuring with the processing unit at least'one of packet: loss, jitter, delay, packet duplication, or packet re-ordering in regard to the data.

14. The method as described in claim 12 wherein there are at*least two paths for sending and receiving the data through the network interface unit to or from the network.

15. The method as described in claim 14 including the step of choosing with the Processing unit at least one path for sending and receiving the data based on either statically defined or dynamic routing information.

16. The method as described in claim 15 including the step of establishing with the processing unit at least one minimum acceptable quality of service threshold which, if not met by the data, causes the processing unit to select an alternate path for the data.

17. The method as described in claim 12 including the step of using a link integrity check algorithm by the processing unit to route the data.

18. The method as described in claim 16 including the steps of determining with the processing unit a quality of service score for each link in a link group and storing by the processing unit each quality of service score in a memory, and if at least one of the quality of service scores falls below the minimum threshold, the processing unit altering the routing of the data to another link group.

19. The method as described in claim 16 including the steps of determining with the processing unit a quality of service score for each link in a link group, and the processing unit storing each quality of service score in the memory, and the processing unit removing a quality of service link from the link group that has a quality of service score below the minimum threshold.

20. The method as described in claim 12 wherein there is an active path and an idle path in regard to the data, and including the step of the processing unit measuring the quality service of the active path.

21. The method as described in claim 20 including a hold, down timer, and wherein when the quality of service of the active path falls below a quality of service threshold, there are the steps of the processing unit diverting the data to the idle path and starting the hold down timer which prevents oscillation of the data being diverted back to the active path if the quality service of the idle path is below the quality service threshold.

22. The method as described in claim 21 including the step of the holddown timer preventing the processing unit from diverting the data to a path having a quality of service below the quality of service threshold which counteracts another node also diverting the data so the data is not diverted from the path having a quality of service below the quality of service threshold.
